(19) United States
(12) Patent Application Publication
(10) Pub. No.: US 2019/0059222 A1
(43) Pub. Date: Feb. 28, 2019

(54) CONTROL SYSTEM FOR AN OFF-ROAD MACHINE

(71) Applicant: AGCO Corporation, Duluth, GA (US)

(72) Inventor: Christian Roberto KELBER, Hesston, KS (US)

(21) Appl. No.: 16/117,270

(22) Filed: Aug. 30, 2018

Related U.S. Application Data
(60) Provisional application No. 62/552,320, filed on Aug. 30, 2017.

(51) Int. Cl. A01D 41/127; A01D 43/08

(52) U.S. Cl. CPC A01D 41/1277; A01D 41/141; A01D 43/086

(57) ABSTRACT

A user interface element includes a plurality of moveable outer points on a circular line and a fixed inner point inside the circular line, the fixed inner point being connected to each of the outer points by a straight line such that each pair of adjacent straight lines and a portion of the circular line between the adjacent straight lines defines a section of the graphical user interface element. The user interface is configured to, in response to interaction from the user, move any of the outer points along the circular line and independently of the other outer points to thereby change the size of two or more of the sections. Each section corresponds to one of a plurality of crop processing parameters, such that changing the amount of area within any section results in an adjustment to an operation of a crop processing system.

### RELATED APPLICATIONS

The present application claims priority under 35 U.S.C. § 119 to U.S. Provisional Application Ser. No. 62/552,320, filed Aug. 30, 2017. The full disclosure, in its entirety, of U.S. Provisional Application Ser. No. 62/552,320 is hereby incorporated by reference.

### FIELD

Embodiments of the present invention relate to control systems for off-road machines. More particularly, embodiments of the present invention relate to control systems for agricultural machines including user interfaces for controlling a plurality of machine operating parameters.

### BACKGROUND

Agricultural harvesting machines, such as combine harvesters, can be complex machines with large and complex crop processing systems. Various components of such systems may be adjusted to optimize any of various performance criteria. By way of example, combine harvesters typically have complex crop processing systems that may include one or more threshing and separating rotors, one or more concave grates associated with each of the one or more rotors, a stratification pan, a return pan and a fan for blowing air through the processing system to thereby separate grain from chaff.

Operating parameters of such a combine harvester may include rotor speed, concave clearance, fan speed and forward travel velocity. Any or all of these operating parameters may be adjusted to optimize any of various criteria such as grain quality, grain loss and operating speed. It may be challenging for even a skilled operator to set all of the operating parameters to achieve a particular performance goal, such as optimizing grain quality. Furthermore, as crop characteristics change (for example, different crops, variations in yield for the same crop, different environmental conditions) machine settings may also need to change to preserve the desired criteria.

The above section provides background information related to the present disclosure which is not necessarily prior art.

### SUMMARY

An agricultural machine according to a first embodiment of the invention comprises a crop processing system, a control system for controlling the crop processing system according to a plurality of crop processing parameters, and a user interface for receiving the plurality of crop processing parameters from a user. The user interface presents a graphical user interface element that includes a circular line defining an outer perimeter of the graphical user interface element, a plurality of moveable outer points on the circular line, and a fixed inner point inside the circular line, the fixed inner point being connected to each of the outer points by a straight line such that each pair of adjacent straight lines and a portion of the circular line between the adjacent straight lines defines a section of the graphical user interface element.

The user interface is configured to, in response to interaction from the user, move any of the outer points along the circular line and independently of the other outer points to thereby change the size of two or more of the sections. An area of each section corresponds to one of the plurality of crop processing parameters, such that changing the amount of area within any section changes the corresponding crop processing parameter and causes the control system to adjust operation of the crop processing system.

An agricultural machine according to another embodiment of the invention comprises a crop processing system, a control system for controlling the crop processing system according to a plurality of crop processing parameters, and a user interface for receiving the plurality of crop processing parameters from a user. The user interface presents a graphical user interface element that includes a circular line defining an outer perimeter of the graphical user interface element, a plurality of moveable outer points on the circular line, and a moveable inner point inside the circular line, the inner point being connected to each of the outer points by a straight line such that each pair of adjacent straight lines and a portion of the circular line between the adjacent straight lines defines a section of the graphical user interface element.

The user interface is configured to, in response to interaction from the user, move the inner point within the circular line to thereby change the size of two or more of the sections. The user interface is further configured to, in response to interaction from the user, move any of the outer points along the circular line and independently of the other outer points to thereby change the size of two or more of the sections. An area of each section corresponds to one of the plurality of crop processing parameters, such that changing the amount of area within any section changes the corresponding crop processing parameter and causes the control system to adjust operation of the crop processing system.

An agricultural machine according to another embodiment of the invention comprises a crop processing system, a control system for controlling the crop processing system according to a plurality of crop processing parameters, and a user interface for receiving the plurality of crop processing parameters from a user. The user interface presents a graphical user interface element that includes a circular line defining an outer perimeter of the element, a plurality of fixed outer points on the circular line, a moveable inner point inside the circular line, the inner point being connected to each of the outer points by a straight line such that each pair of adjacent straight lines and a portion of the circular line between the adjacent straight lines defines a section of the graphical user interface element.

The user interface is configured to, in response to interaction from the user, move the inner point within the circular line to thereby change the size of two or more of the sections. An area of each section corresponds to one of the plurality of crop processing parameters, such that changing the amount of area within any section changes the corresponding crop processing parameter and causes the control system to adjust operation of the crop processing system.

These and other important aspects of the present invention are described more fully in the detailed description below. The invention is not limited to the particular methods and systems described herein. Other embodiments may be used and/or changes to the described embodiments may be made without departing from the scope of the claims that follow the detailed description.

### DRAWINGS

Embodiments of the present invention are described in detail below with reference to the attached drawing figures, wherein:

FIG. 1 is a diagram of certain portions of a combine harvester constructed in accordance with embodiments of the invention.

FIG. 2 is a block diagram illustrating the interaction of certain systems and components of the combine harvester of FIG. 1.

FIGS. 3-4 illustrate an exemplary graphical user interface element associated with a user interface of the combine harvester of FIG. 1.

FIGS. 5-6 illustrate another exemplary graphical user interface element associated with the user interface of the combine harvester of FIG. 1.

FIGS. 7-8 illustrate another exemplary graphical user interface element associated with the user interface of the combine harvester of FIG. 1.

FIGS. 9-10 illustrate another exemplary graphical user interface element associated with the user interface of the combine harvester of FIG. 1.

FIGS. 11-12 illustrate another exemplary graphical user interface element associated with the user interface of the combine harvester of FIG. 1.

FIGS. 13-14 illustrate another exemplary graphical user interface element associated with the user interface of the combine harvester of FIG. 1.

The drawing figures do not limit the present invention to the specific embodiments disclosed and described herein. The drawings are not necessarily to scale, emphasis instead being placed upon clearly illustrating the principles of the invention.

### DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the spirit and scope of the invention as defined by the claims. The following description is, therefore, not to be taken in a limiting sense. Further, it will be appreciated that the claims are not necessarily limited to the particular embodiments set out in this description.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

When elements or components are referred to herein as being “connected” or “coupled,” the elements or components may be directly connected or coupled together or one or more intervening elements or components may also be present. In contrast, when elements or components are referred to as being “directly connected” or “directly coupled,” there are no intervening elements or components present.

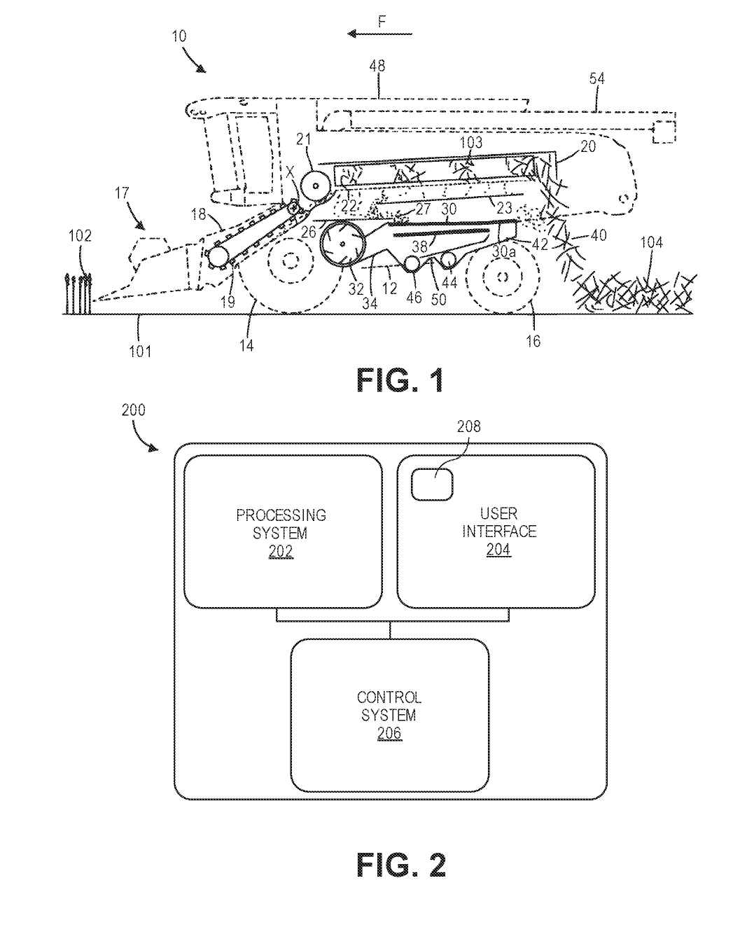

With reference to FIG. 1 a combine harvester 10 includes a frame 12, front wheels 14 and rear steerable wheels 16, the wheels engaging with the ground 101. A cutting header 17 is detachably supported on the front of a feederhouse 18 which is pivotable about a transverse axis X to lift and lower the header 17 in a conventional manner.

The combine 10 is driven in a forward direction (arrow F) across a field of standing crop 102 in a known manner. The header 17 serves to cut and gather the crop material before conveying such into feederhouse 18 and the elevator 19 housed therein. At this stage the crop stream is unprocessed. It should be understood that combine harvesters are employed to harvest a host of different crops including cereal, rice, corn and grass seed. The following description will make reference to various parts of a cereal crop stream but it should be understood that this is by way of example only and does not by any means limit the applicability of the invention to harvesting other harvested crops.

The cut crop stream is conveyed rearwardly from the feederhouse 18 to a crop processing system designated generally at 20. The processing system 20 of the illustrated combine includes an axial flow threshing and separating rotor which is fed at its front end by a feed beater 21. Axial flow rotor 20 serves to thresh the crop stream in a front region, separate the grain therefrom in a rear region, and eject the straw residue through the rear of the machine either directly onto the ground in windrow or via a straw chopper (not shown). A concaved grate 22 in the underside of the threshing and separating rotor 20 allows the separated material to fall by gravity onto a return pan 23 located below.

Return pan 23 comprises a tray-like structure and serves to convey the collected grain forwardly (in the direction F) to a respective front edge thereof in a known manner. It should be understood that the term “pan” will be used for grain conveyance components which serve to convey grain in a given direction. This is in contrast to “sieves” which include a perforated structure to separate material and will be described in more detail below.

At this stage in the process a mix of grain, kernels, chaff, unthreshed tailings and shorter straw have been separated from the majority of the straw residue, the separated mix having fallen through the concave or grate of processor 20 onto the return pan 23. The remaining straw residue 103 continues in a spiral path around the axial rotor 20 to the rear from where it is discharged onto the ground in a windrow 104. The separated crop mix will hereinafter be referred to as a grain-MOG mix wherein MOG refers to material other than grain and includes the straw and chaff.

The grain-MOG mix falls onto a grain pan 26 which will hereinafter be referred to as “stratification pan” 26 for reasons to become apparent below. The stratification pan 26 is driven in a similar oscillating manner to the return pan, that is in a fore-and-aft oscillating motion which may be linear or partly circular. The stratification pan floor is transversely corrugated, or rippled, with a saw-toothed profile. The combination of the saw-toothed profile with the oscillating motion conveys the grain-MOG mix in a generally rearward direction towards a rear edge 27 from where the mix falls onto the front of a top sieve or chaffer 30.

As the grain-MOG mix falls from the stratification pan rear edge it is subjected to a cleaning airstream generated by fan unit 32 which includes a cross-flow fan in a fan housing. Alternatively, a centrifugal fan may be employed. Ducting 34 directs the pressurized air under the rear edge 27, the airstream serving to blow the MOG upwardly and rearwardly towards the rear of the machine. This process will be described in more detail later on.

Chaffer 30 comprises adjustable louvres supported on a chaffer frame which is driven in fore-and-aft oscillating manner. The material which settles on the chaffer 30 is conveyed in a generally rearward direction and the heavier smaller grain-rich material passes between the louvres onto an underlying lower sieve 38, whereas the lighter larger material passes to the end of the chaffer and out of the rear of the machine at 40. A rear section of chaffer 30a may be independently adjustable and is configured to allow un-threshed tailings to pass therethrough into a re-threshing region 42 from where the tailings are conveyed to a re-threshing auger 44.

Lower sieve 38 is also driven in an oscillating manner to convey the collected grain-MOG mix rearwardly wherein the material falling therethrough is collected in a clean grain trough 46 for conveyance by an elevator (not shown) to a grain tank 48. Material which does not pass through lower sieve 38 and is instead conveyed off the rear edge thereof falls into re-threshing region 42 for subsequent rethreshing in accordance with known principles.

The airstream generated by fan unit 32 is also conveyed by ducting up through lower sieve 38 and chaffer 30 to encourage lifting of the MOG from the chaffer surface. For ease of reference hereinafter the chaffer 30, lower sieve 38, fan unit 32 will be collectively referred to as “the cleaning shoe 50”. Moreover, the return pan 23 and stratification pan 26 will be referred to as “the crop material transfer system” which serves the purpose of transferring the material separated by the processor 20 to the cleaning shoe 50. For completeness the combine 10 includes an unloading system which includes an unloading auger 54 shown in part in FIG. 1.

An exemplary agricultural machine system 200 in accordance with embodiments of the invention is illustrated in FIG. 2 and includes a crop processing system 202, a user interface 204 and a control system 206. The machine system 200 may be associated with the combine harvester 10 described above, and the crop processing system 202 may be similar or identical to the processing system 20 described above. The user interface 204 includes a visual display 208, such as a touch screen, that presents a graphical user interface element. The graphical user interface element is configured to facilitate operator control of or input for multiple operating parameters as described below in greater detail. The visual display 208 may be physically integral with or connected to the host machine, such as, a display console built into or attached to a portion of an operator cabin of the host machine. Alternatively, the visual display 208 may not be physically connected or attached to the host machine but may be, for example, a hand-held electronic device in wireless communication with the control system 206. Examples of hand-held electronic devices include tablet computers, smartphones and laptop computers.

The control system 206 is in communicate with both the crop processing system 202 and the user interface 204. The control system 206 controls the crop processing system 202 according to various operating parameters, and may receive one or more of the operating parameters from an operator via the user interface 204. In particular, the control system 206 may receive the operating parameters from the operator via the graphical user interface element.

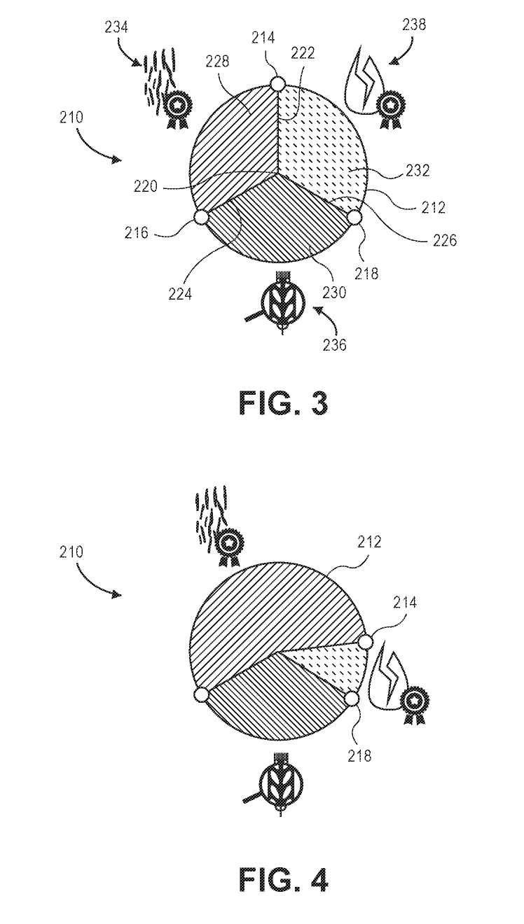

A first exemplary graphical user interface element 210 is illustrated in FIGS. 3 and 4. The element 210 includes a circular line 212 defining an outer perimeter of the element, a plurality of moveable outer points 214, 216, 218 on the circular line 212, a fixed inner point 220 inside the circular line 212 and a plurality of straight lines 222, 224, 226 each connecting the fixed inner point 220 to one of the moveable outer points 214, 216, 218. The fixed inner point 220 is connected to each of the outer points 214, 216, 218 by a straight line such that each pair of adjacent straight lines and a portion of the circular line 212 between the adjacent straight lines defines a section of the graphical user interface element 210. The user interface element 210 includes three sections 228, 230, 232. Each of the sections may present a different appearance, such as a different fill pattern or a different color.

The user interface 204 is configured to, in response to interaction from the user, move any of the outer points 214, 216, 218 along the circular line 212 and independently of the other outer points to thereby change the size of two or more of the sections 228, 230, 232. An area of each section of the user interface element 210 corresponds to one of the plurality of crop processing parameters used by the control system 206 to govern operation of the crop processing system 202, such that changing the amount of area within any section 228, 230, 232 changes the corresponding crop processing parameter, which may result in the control system 206 adjusting operation of the crop processing system 202.

The user interface element 210 includes a single inner point 220 and three outer points 214, 216, 218 defining three sections 228, 230, 232, each corresponding to one crop processing parameter. In this example the crop processing parameters include grain loss as indicated by icon 234, grain cleanness as indicated by icon 236, and grain quality as indicate by icon 238. The grain loss parameter relates to the amount of grain lost in the tailings discharged from the crop processing system 202. The larger the section, the more emphasis is placed on minimizing the amount of grain loss. The grain cleanness parameter relates to the amount of material other than grain (MOG) in the harvested grain. The larger the section, the more emphasis is placed on reducing the amount of MOG in the harvested grain. The grain quality parameter relates to the amount of damaged grain in the harvested grain. The larger the section, the more emphasis is placed on minimizing the extent of grain damage.

In FIG. 3 the outer points 214, 216, 218 of the user interface element 210 are approximately evenly spaced such that none of the crop processing parameters is emphasized more than any of the others. The user interface 204 allows the operator to adjust the user interface element 210 such that different crop processing parameters are given different weight or emphasis than others, as illustrated in FIG. 4. In FIG. 4 outer point 214 has been moved along the circular line 212 in the direction of the outer point 218, such that the section corresponding to grain loss is larger and the section corresponding to grain quality is smaller. This change affects system operation by placing a greater emphasis on preventing grain loss and less of an emphasis on preventing grain damage. The result is that there will be less grain lost in the tailings of the combine harvester but potentially a greater amount of damaged crop, such as cracked or broken grain. If the display 208 is a touchscreen, the user may move any of the outer points 214, 216, 218 by simply touching the screen at the location of the point to be moved and “dragging” the point by moving his or her finger along the screen. In this embodiment of the invention, the outer points 214, 216, 218 may be moved only along the line 212, and none of the points 214, 216, 218 may cross another of the points.

The user interface element 210 provides a simple and convenient way for an operator to adjust operation of the crop processing system 202 without adjusting settings of individual components of the system 202 such as concave clearance, rotor speed or fan speed. The control system 206 is configured to automatically make those types of adjustments to achieve the operating parameter priorities set via the user interface element 210, thus relieving the operator of the need to focus on those details. Using the user interface element 210, a machine operator can quickly and easily adjust the operating parameters of the machine, even on-the-go during a harvest operation.

The crop processing system 202 may include sensors for detecting grain loss, broken grain, and MOG in the harvested grain, and use data from those sensors to adjust components of the processing system 202 to achieve the operating parameters indicated by the user interface element 210. By way of example, the control system 206 may continuously determine a percentage of grain loss, a percentage of broken grain and a percentage of MOG in the harvested grain using data from sensors in the processing system 202. It may then adjust operating settings in the processing system 202 to adjust each percentage to reflect changes in the user interface element 210. In response to the change illustrated in FIGS. 3 and 4, for example, the crop processing system may position the concave grates closer to the rotor, decrease the fan speed, or both.

The adjustment to the user interface element illustrated in FIG. 4 also has the effect of prioritizing parameters. Grain cleanness is the top priority, grain loss is the second priority and grain quality is the last priority.

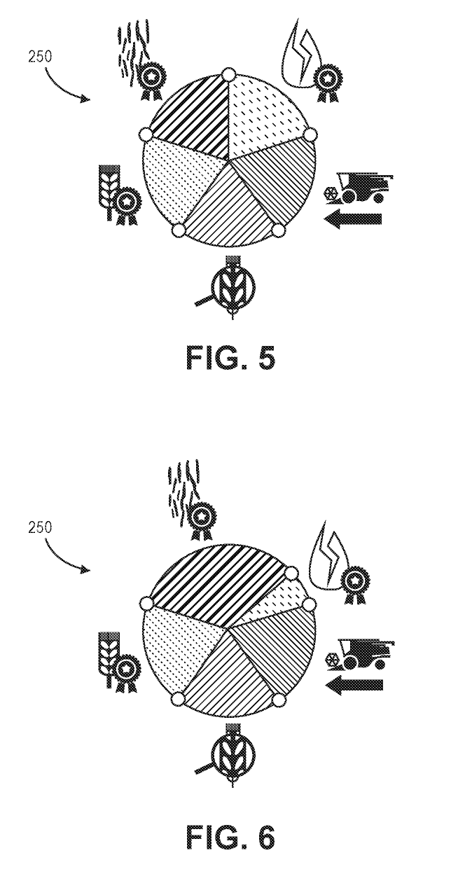

Another exemplary user interface element 250 is illustrated in FIGS. 5 and 6. The user interface element 250 is similar to the user interface element 210 described above, except that the user interface element 250 includes five moveable outer points and five sections as opposed to three. As with the user interface element 210, each section corresponds to a different crop processing parameter. In this case the crop processing parameters include grain cleanness, grain quality, travel speed, grain loss and total grain throughput. The user interface element 250 functions in a manner similar to the user interface element 210 described above, and the user interface 204 allows the operator to adjust the position of any of the outer points independently of the other outer points to thereby adjust the size of two or more of the sections and adjust the crop processing parameters corresponding to the sections. In FIG. 6, for example, the position of an outer point has been moved to increase the size of the section corresponding to grain loss and decrease the size of the section corresponding to grain quality. Any or all of the outer points may be moved to create virtually any configuration of point locations and section sizes.

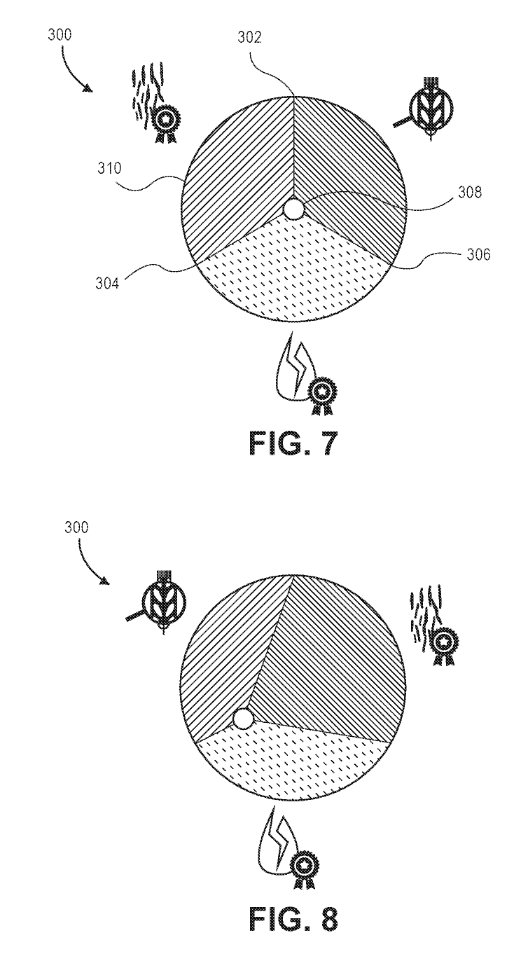

Another exemplary user interface element 300 is illustrated in FIGS. 7 and 8. The user interface element 300 is similar to the user interface element 210 described above and includes a plurality of fixed outer points 302, 304, 306 and a moveable inner point 308. The outer points 302, 304, 306 are each fixed in position on the circular line 310 while the inner point 308 is moveable within the circular line 310, as illustrated in FIG. 8. The moveable inner point 308 is connected to each of the fixed outer points 302, 304, 306 by a straight line such that each pair of adjacent straight lines and a portion of the circular line 310 between the adjacent straight lines defines a section of the graphical user interface element 300.

The user interface element 300 is configured to, in response to interaction from the user, move the inner point 308 inside the circular line 310, as illustrated in FIG. 8. An area of each section of the user interface element 300 corresponds to one of the plurality of crop processing parameters, such that changing the amount of area within any section changes the corresponding crop processing parameter and causes the control system to adjust operation of the crop processing system, as explained above in relation to the user interface elements 210 and 250.

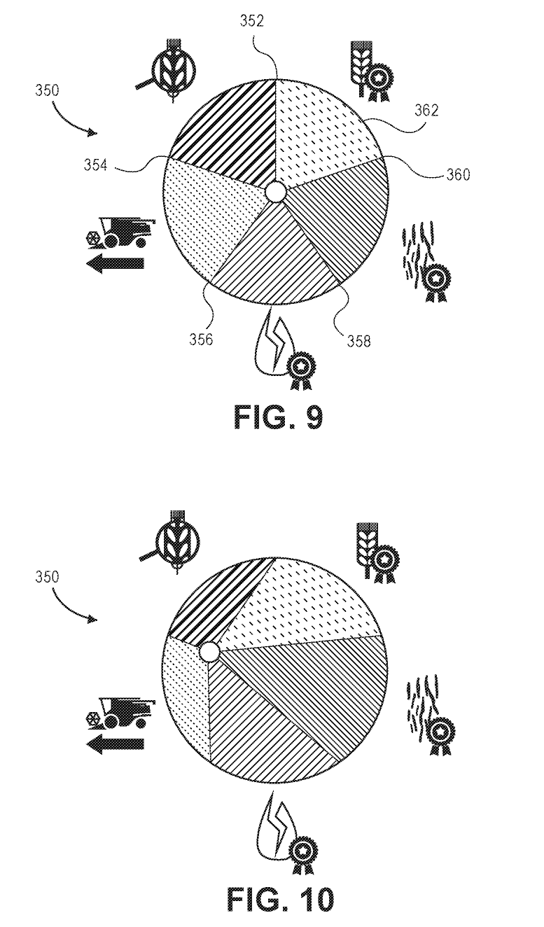

Another exemplary user interface element 350 is illustrated in FIGS. 9 and 10. The user interface element 350 is similar to the user interface element 300 illustrated in FIGS. 7 and 8, except that the user interface element 350 includes five fixed outer points 352, 354, 356, 358, 360 located on the circular line 362 defining five sections. Each of the five sections corresponds to a crop processing parameter, and the size of the sections may be adjusted by moving the inner point within the circular line, as illustrated in FIG. 10.

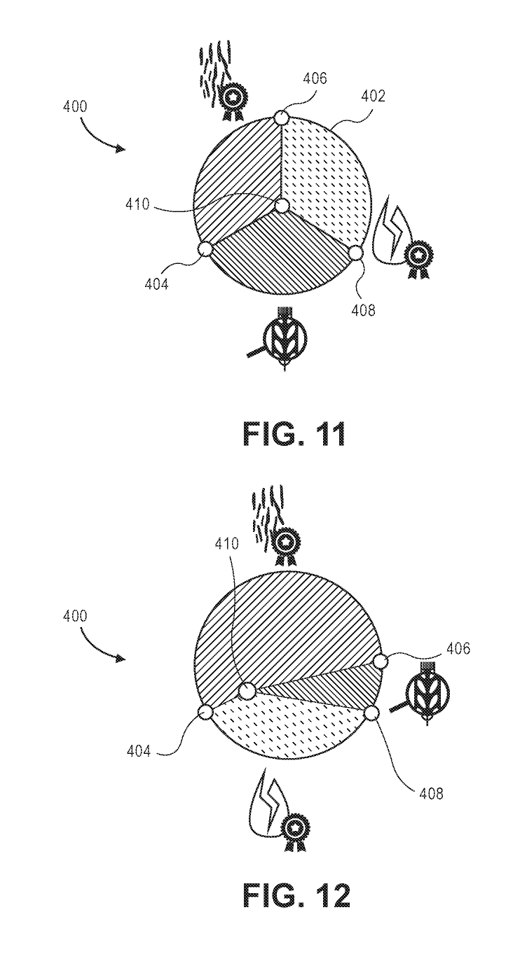

Another exemplary user interface element 400 is illustrated in FIGS. 11 and 12. The user interface element 400 is similar to the user interface element 210 described above and includes a plurality of moveable outer points 404, 406, 408, but also includes a moveable inner point 410. The outer points 404, 406, 408 are each moveable along the line 402 independently of the other outer points, as explained above in relation to user interface element 210, and the inner point 410 is moveable within the circular line 402, as illustrated in FIG. 12. The inner point 410 is connected to each of the outer points 404, 406, 408 by a straight line such that each pair of adjacent straight lines and a portion of the circular line 402 between the adjacent straight lines defines a section of the graphical user interface element 400. The straight lines connecting the inner and outer points remain fixed to the inner and outer points regardless of the location of the inner and outer points. This provides the user with a substantial degree of flexibility with regard to the size of each of the sections of the element 400.

The user interface element 400 is configured to, in response to interaction from the user, move the inner point 410 inside the circular line 402, as illustrated in FIG. 8. An area of each section of the user interface element 400 corresponds to one of the plurality of crop processing parameters, such that changing the amount of area within any section changes the corresponding crop processing parameter and causes the control system 206 to adjust operation of the crop processing system 202, as explained above in relation to the user interface elements 210 and 250.

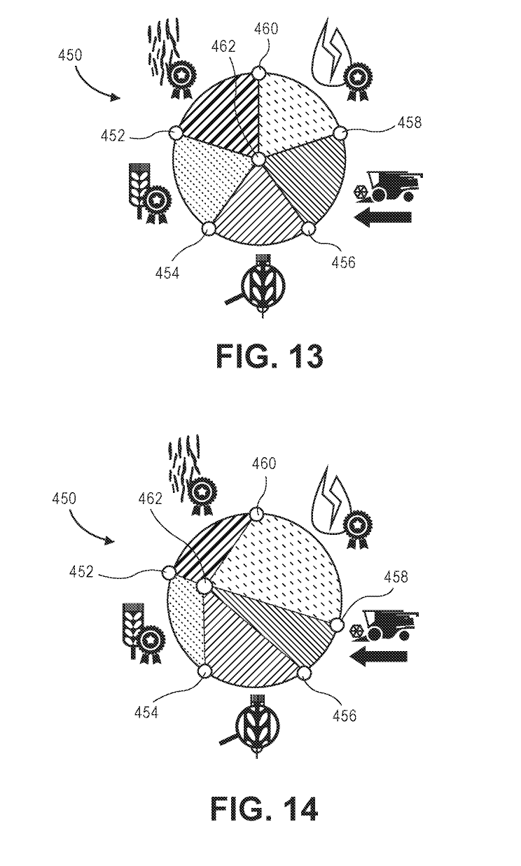

Another exemplary user interface element 450 is illustrated in FIGS. 13 and 14. The user interface element 450 is similar to the user interface element 400 described above, except that the user interface element 450 includes five moveable outer points 452, 454, 456, 458, 460 and five sections as opposed to three. The user interface element 450 includes a moveable inner point 462 that may be moved and positioned anywhere inside the element 450. As with the user interface element 400, each section corresponds to a different crop processing parameter. In this case the crop processing parameters include grain cleanness, grain quality, travel speed, grain loss and total grain throughput. The user interface element 450 functions in a manner similar to the user interface element 400 described above. The user interface 204 allows the operator to adjust the position of any of the outer points 452, 454, 456, 458, 460 independently of the other outer points to thereby adjust the size of two or more of the sections and adjust the crop processing parameters corresponding to the sections. The user interface 204 also allows the operator to adjust the position of the inner point 462 in addition to adjusting the positions of the outer points 452, 454, 456, 458, 460. In FIG. 14, for example, the position of outer point 458 has been moved to increase the size of the section corresponding to grain damage and decrease the size of the section corresponding to ground speed. Furthermore, the inner point 462 has been moved generally toward the left in the drawing, which has the effect of generally increasing the size of the sections on the right side of the element 450 and generally decreasing the size of the sections on the left side of the element 450. Any or all of the outer points may be moved to create virtually any configuration of point locations and section sizes.

The user interface 204 may be configured to allow the operator to customize the graphical user interface element. By way of example, the operator may be able to change the crop processing parameter assigned to each section of the user interface element. With reference to FIG. 3, to make that change, for example, a user may select a configuration option via a menu (not shown) of the user interface and, when the user interface 204 is in a configuration mode, physically touch, drag and drop two or more of the icons 234, 236, 238 to the desired location. Additionally, the user interface 204 may allow the operator to choose from among a list of possible crop processing parameters, including parameters not currently assigned to the graphical user interface element. When the user interface 204 is in the configuration mode, for example, it may present a visual list of possible parameters and allow the operator to select a number of the parameters for inclusion in the graphical user interface element. Using this approach, the operator may tap on one of the sections of the graphical user interface element to select that section, then select a parameter from the list of parameters to assign that parameter to the selected section. This is but one example of how crop processing parameters may be assigned to sections of the graphical user interface element.

The user interface 204 may also be configured to allow the operator to customize the graphical user interface element by adding or removing sections and the corresponding crop processing parameters. To add a section, for example, the user may select a configuration option, as explained above, wherein the user interface responds by presenting a list of possible crop processing parameters. The user may select an additional parameter from the list, wherein the user interface 204 adds another outer point and a straight line connecting the outer point to the inner point. This action adds another section to the graphical user interface element and the newly-selected parameter is assigned to the new section. The user interface 204 may similarly remove a section and the corresponding crop processing parameter by removing an outer point and the line connecting the outer point to the inner point and combining the two sections that were previously divided by the line connecting the inner point and the (now removed) outer point.

Although the invention has been described with reference to the preferred embodiment illustrated in the attached drawing figures, it is noted that equivalents may be employed and substitutions made herein without departing from the scope of the invention as recited in the claims. By way of example, the graphical user interface element may include a number of sections other than those shown and illustrated in the drawing figures. The graphical user interface element may include, for example, two sections, four sections, six sections, seven sections or even more.

Having thus described the preferred embodiment of the invention, what is claimed as new and desired to be protected by Letters Patent includes the following:

1. An agricultural machine comprising:
a crop processing system;
a control system for controlling the crop processing system according to a plurality of crop processing parameters; and
a user interface for receiving the plurality of crop processing parameters from a user, the user interface presenting a graphical user interface element including—
a circular line defining an outer perimeter of the graphical user interface element,
a plurality of moveable outer points on the circular line, and
a fixed inner point inside the circular line, the fixed inner point being connected to each of the outer points by a straight line such that each pair of adjacent straight lines and a portion of the circular line between the adjacent straight lines defines a section of the graphical user interface element;
wherein the user interface is configured to, in response to interaction from the user, move any of the outer points along the circular line and independently of the other outer points to thereby change the size of two or more of the sections,
wherein an area of each section corresponds to one of the plurality of crop processing parameters, such that changing the amount of area within any section changes the corresponding crop processing parameter and causes the control system to adjust operation of the crop processing system.

2. The agricultural machine as set forth in claim 1, the user interface configured to, in response to interaction from the user, assign a crop processing parameter to each of the sections of the user interface element.

3. The agricultural machine as set forth in claim 1, the user interface configured to, in response to interaction from the user, add a section to the user interface element by adding an additional outer point and a straight line from the additional outer point to the fixed inner point.

4. The agricultural machine as set forth in claim 1, the user interface configured to, in response to interaction from the user, remove a section from the user interface element by removing an outer point and removing the straight line associated with the removed outer point.

5. The agricultural machine as set forth in claim 1, the agricultural machine being a combine harvester and the crop processing parameters including ground speed, grain loss and grain quality.

6. The agricultural machine as set forth in claim 5, the crop processing parameters further including grain cleanness and crop throughput.

7. The agricultural machine as set forth in claim 1, the user interface presenting the graphical user interface element on a touchscreen and configured to move any of the outer points along the circular line in response to a user touching the touchscreen.

8. An agricultural machine comprising:
a crop processing system;
a control system for controlling the crop processing system according to a plurality of crop processing parameters; and
a user interface for receiving the plurality of crop processing parameters from a user, the user interface presenting a graphical user interface element including—
a circular line defining an outer perimeter of the graphical user interface element,
a plurality of moveable outer points on the circular line, and
a moveable inner point inside the circular line, the inner point being connected to each of the outer points by a straight line such that each pair of adjacent straight lines and a portion of the circular line between the adjacent straight lines defines a section of the graphical user interface element;
wherein the user interface is configured to—
in response to interaction from the user, move the inner point within the circular line to thereby change the size of two or more of the sections,
in response to interaction from the user, move any of the outer points along the circular line and independently of the other outer points to thereby change the size of two or more of the sections,
wherein an area of each section corresponds to one of the plurality of crop processing parameters, such that changing the amount of area within any section changes the corresponding crop processing parameter and causes the control system to adjust operation of the crop processing system.

9. The agricultural machine as set forth in claim 8, the user interface configured to, in response to interaction from the user, assign a crop processing parameter to each of the sections of the user interface element.

10. The agricultural machine as set forth in claim 8, the user interface configured to, in response to interaction from the user, add a section to the user interface element by adding an additional outer point and a straight line from the additional outer point to the inner point.

11. The agricultural machine as set forth in claim 8, the user interface configured to, in response to interaction from the user, remove a section from the user interface element by removing an outer point and removing the straight line associated with the removed outer point.

12. The agricultural machine as set forth in claim 8, the agricultural machine being a combine harvester and the crop processing parameters including ground speed, grain loss and grain quality.

13. The agricultural machine as set forth in claim 12, the crop processing parameters further including grain cleanness and crop throughput.

14. The agricultural machine as set forth in claim 8, the user interface presenting the graphical user interface element on a touchscreen and configured to move any of the outer points along the circular line and move the inner point inside the circular line in response to a user touching the touchscreen.

15. An agricultural machine comprising:
a crop processing system;
a control system for controlling the crop processing system according to a plurality of crop processing parameters; and
a user interface for receiving the plurality of crop processing parameters from a user, the user interface presenting a graphical user interface element including—
a circular line defining an outer perimeter of the element,
a plurality of fixed outer points on the circular line,
a moveable inner point inside the circular line, the inner point being connected to each of the outer points by a straight line such that each pair of adjacent straight lines and a portion of the circular line between the adjacent straight lines defines a section of the graphical user interface element;
wherein the user interface is configured to, in response to interaction from the user, move the inner point within the circular line to thereby change the size of two or more of the sections,
wherein an area of each section corresponds to one of the plurality of crop processing parameters, such that changing the amount of area within any section changes the corresponding crop processing parameter and causes the control system to adjust operation of the crop processing system.

16. The agricultural machine as set forth in claim 15, the user interface configured to, in response to interaction from the user, assign a crop processing parameter to each of the sections of the user interface element.

17. The agricultural machine as set forth in claim 15, the user interface configured to, in response to interaction from the user, add a section to the user interface element by adding an additional outer point and a straight line from the additional outer point to the inner point.

18. The agricultural machine as set forth in claim 15, the user interface configured to, in response to interaction from the user, remove a section from the user interface element by removing an outer point and removing the straight line associated with the removed outer point.

19. The agricultural machine as set forth in claim 15, the agricultural machine being a combine harvester and the crop processing parameters including ground speed, grain loss and grain quality.

20. The agricultural machine as set forth in claim 19, the crop processing parameters further including grain cleanness and crop throughput.
